(19) United States
(12) Patent Application Publication
(10) Pub. No.: US 2017/0108658 A1
(43) Pub. Date: Apr. 20, 2017

(54) MULTIPLE CIRCUIT CABLE

(71) Applicant: YAZAKI CORPORATION, Tokyo (JP)

(72) Inventors: Hiroki KONDO, Susono-shi (JP); Satoru YOSHINAGA, Susono-shi (JP)

(73) Assignee: YAZAKI CORPORATION, Tokyo (JP)

(21) Appl. No.: 15/393,411

(22) Filed: Dec. 29, 2016

Related U.S. Application Data
(63) Continuation of application No. PCT/JP2015/068907, filed on Jun. 30, 2015.

(30) Foreign Application Priority Data
Jun. 30, 2014 (JP) 2014-134157
Jun. 30, 2014 (JP) 2014-134203

(51) Int. Cl. G02B 6/44; H01B 7/08; H01B 7/00

(52) U.S. Cl. CPC G02B 6/4416; H01B 7/0045; H01B 7/0869; G02B 6/443; G02B 6/4471

(57) ABSTRACT

A multiple circuit cable includes an inside transfer body that transfers a first signal or a first power, an inside insulator that covers an outer circumference of the inside transfer body, an outside transfer body that is disposed on an outside of the inside insulator and transfers a second signal or a second power, and an outside insulator that covers an outer circumference of the outside transfer body. The outside transfer body is configured with a plurality of conductive fibers having conductivity. The outside transfer body has a thickness so that an outer shape is a flattened into a flat-shape when an external force is applied.

### CROSS REFERENCE TO RELATED APPLICATIONS

This application is a continuation of PCT application No. PCT/JP2015/068907, which was filed on Jun. 30, 2015 based on Japanese Patent Application (No. 2014-134157) filed on Jun. 30, 2014, and Japanese Patent Application (No. 2014-134203) filed on Jun. 30, 2014, the contents of which are incorporated herein by reference.

### BACKGROUND OF THE INVENTION

Field of the Invention

The present invention relates to a multiple circuit cable.

Description of Related Art

In the related art, a multiple circuit cable is proposed which includes an optical fiber that transfers an optical signal, and a conductor that transfers electric power or an electric signal, in which a plurality of circuits (optical fibers or conductors) are included in one cable (refer to Patent Literature 1: JP-A-2010-181600). The cable is configured to include an optical fiber, a coat which covers the outer circumference of the optical fiber, a metal conductor which has a pipe shape in which metal wires of such as soft copper that are provided on the coat are disposed without a gap therebetween, and an external cover which covers these. Furthermore, in addition to the aforementioned configuration, a cable is also proposed which includes a tension member that is configured by a tensile force fiber for relaxing a tensile force which is applied to an optical fiber between a coat of the optical fiber and the metal conductor (refer to Patent Literature 2: JP-A-2014-63584).

### [Patent Literature 1] JP-A-2010-181600

### [Patent Literature 2] JP-A-2014-63584

A cable described in Patent Literature 1 uses a metal wire of such as soft copper for a metal conductor. Here, a diameter of the metal wire is limited to approximately 50 μm in view of work in a case where mass-productivity is considered. That is, in the cable described in Patent Literature 1, a layer of the metal conductor has a thickness of a certain magnitude, and thus, a diameter thereof has a certain magnitude. Hence, a method of configuring, for example, a thin external cover for reducing the diameter of the cable is employed.

However, in a case where the external cover is configured to be thinned, a problem of abrasivity occurs. That is, in a case where a multiple circuit cable is used in a place where vibration or the like is applied, there are problems that an external cover is gradually scraped due to the vibration or the like, the number of use years of the multiple circuit cable having a thin external cover is reduced, and the like. Particularly, the cable described in Patent Literature 1 includes a hard transfer body which is called an optical fiber in its inside, and thus, in a case where an external force is applied to the cable, the external force is applied to the hard optical fiber, and thereby, an external cover thereof is easily scraped.

In this way, it is difficult to obtain both reduction of a diameter and an increase of abrasion resistance for a multiple circuit cable.

In addition, in a cable described in Patent Literature 2, terminal processing for each of three layers needs to be performed, and thus, the terminal processing is significantly complicated. That is, it is necessary to perform three terminal processings of 1) connection processing of an optical fiber, 2) processing of maintaining the tension of a tension member (processing of attaching to a target object after being pulled to some extent), and 3) connection processing of an electric wire, and thus, work is significantly complicated.

Particularly, terminal processing of the tension member is significantly complicated. Specifically, in a case where the terminal processing of the tension member is performed, work of cutting a tensile force fiber with a cutting blade is needed. However, it is difficult to cut the tensile force fiber with a normal cutting blade, and the cutting work itself is complicated. In addition, the tensile force fiber is configured by bundling a certain number of fibers together, processing of cutting or maintaining the tension has to be performed, and the bundling work itself is also complicated.

In addition, the cable described in Patent Literature 2 employs thin electric wires which are disposed around an optical fiber, and thus, work of extracting the electric wires one by one to connect to a certain target is performed. Hence, as a weight is applied to one thin electric wire, there is a high probability that an electric wire will be cut.

### SUMMARY

One or more embodiments provide a multiple circuit cable in which a diameter can be reduced so as to increase abrasion resistance, and in which complexity of terminal processing can be reduced so as to reduce probability that an electric wire is cut.

In an aspect (1), one or more embodiments provide a multiple circuit cable including an inside transfer body that transfers a first signal or a first power, an inside insulator that covers an outer circumference of the inside transfer body, an outside transfer body that is disposed on an outside of the inside insulator and transfers a second signal or a second power, and an outside insulator that covers an outer circumference of the outside transfer body. The outside transfer body is configured with a plurality of conductive fibers with conductivity. The outside transfer body has a thickness so that an outer shape is flattened into a flat-shape when an external force is applied.

According to the aspect (1), the outside transfer body is configured by a plurality of conductive fibers with conductivity, and thus, a thickness thereof can be thinned, compared to a case where the outside transfer body is configured by a metal wire, without using a metal wire with quite a large diameter. Furthermore, since the outside insulator has hardness which is greater than or equal to 10 and less than or equal to 90 and the outside transfer body is configured by the conductive fibers, one part of the conductive fibers may be moved by an external force so as to be interposed between another part of the conductive fibers, and the outside insulator itself may be appropriately deformed, and thus, the cables themselves may become flat-shaped, for example, under an environment in which an external force is applied to the outside insulator and thereby abrasion occurs. That is, the shape changes so as to dissipate the external force, and thereby the outside insulator can be hard to become worn out. Hence, it is possible to provide the multiple circuit cable in which a diameter can be reduced and abrasion resistance can be increased.

Since an outside insulator has hardness greater than or equal to 10, it is possible to prevent a situation from occurring in which the outside insulator is too soft thereby being easily worn out. Since the outside insulator has hardness less than or equal to 90, it is possible to prevent a situation from occurring in which the outside insulator is too hard thereby being hard to be flattened.

In an aspect (2), in the multiple circuit cable, each of the conductive fibers is a plated fiber which is produced by plating a metal on a fiber.

According to the aspect (2), since the conductive fiber is a plated fiber in which a metal is plated on the fiber, the conductive fiber can be employed by adjusting a thickness of the plated metal, even in a circuit whose conductivity is insufficient only by a carbon fiber or the like with conductivity.

In an aspect (3), in the multiple circuit cable, the each of the conductive fibers is plated by one or more metals of copper, tin, nickel, gold, and silver on a fiber.

According to the aspect (3), since the conductive fiber is configured by plating one or more metals of copper, tin, nickel, gold, and silver on a fiber, it is possible to provide a conductive fiber which is easily plated and has high conductivity.

In an aspect (4), in the multiple circuit cable, the fiber is any one of an aramid fiber, a polyarylate fiber, a PBO fiber, and a carbon fiber.

According to the aspect (4), a fiber is any one of an aramid fiber, a polyarylate fiber, a PBO fiber, and a carbon fiber. For this reason, the fiber is resistant to heat, and thus, it is possible to connect the conductive fiber to a terminal using solder. Furthermore, since the fiber has a tensile strength greater than or equal to 1 GPa and has an elastic modulus greater than or equal to 50 GPa, stress relaxation can be hard to occur in the fiber, when a terminal is attached to the conductive fiber by pressing. Hence, when the terminal is connected, it is possible to prevent performance of a product from being degraded.

In an aspect (5), in the multiple circuit cable, the each of the conductive fibers has a diameter which is larger than or equal to 5 μm and smaller than or equal to 30 μm.

According to the aspect (5), since the conductive fiber has a diameter greater than or equal to 5 μm, it is possible to prevent a situation from occurring in which the conductive fiber is too thin thereby being easily cut. In addition, since the conductive fiber has a diameter less than or equal to 30 μm, it is possible to prevent a situation from occurring in which the conductive fiber is hard to be interposed between other conductive fibers due to too great a thickness, and the cables are hard to be flattened.

In an aspect (6), in the multiple circuit cable, the inside transfer body is an optical fiber which transfers an optical signal.

According to the aspect (6), since the inside transfer body is an optical fiber which transfers an optical signal, it is possible to provide the cables in which a hard optical fiber receives an external force from the outside of the cable, and in a situation where the more outside insulator is scraped, a shape thereof is deformed to dissipate the external force, and the outside insulator can be hard to become worn out.

In an aspect (7), a wire harness according to the present invention includes the multiple circuit cable described above, and other cables that are disposed in parallel to be adjacent to the multiple circuit cable.

According to the aspect (7), since the multiple circuit cable and other cables disposed in parallel to be adjacent to the multiple circuit cable are included, it is possible to provide a wire harness in which the adjacent cables are pressed to the multiple circuit cable, or the multiple circuit cable is pressed to the adjacent cables, and thus, even in an environment where the multiple circuit cable or other cables are worn out, the multiple circuit cable is flattened, and thereby the multiple circuit cable or other cables are not worn out.

In an aspect (8), one or more embodiments provide a multiple circuit cable including an optical fiber that transfers an optical signal, and a plurality of electric wire layers that are disposed around the optical fiber. The electric wire layer includes a plurality of coated plating fiber bundles. Each of the plurality of the coated plating fiber bundles is a bundle of a plurality of plated fibers, the bundle is coated with a resin, and the each of the plurality of plated fibers is plated by a metal on a tensile force fiber.

According to the aspect (8), the electric wire layer is configured by disposing a plurality of the coated plating fiber bundles which are coated with the resin by bundling a plurality of the plated fibers in which a metal is plated on a tensile force fiber, around the optical fiber. For this reason, a coated plating fiber bundle having functions of both the tension member and the electric wire is disposed around the optical fiber. Thereby, a cable can have a two-layer structure of an optical fiber and an electric wire layer, and a diameter of the cable can be reduced.

Furthermore, since the cable has a two-layer structure, terminal processing may be performed only for two layers, and thus, complexity is reduced. Particularly, since the coated plating fiber bundle is configured by bundling a plurality of the plated fibers and is coated with the resin, work of bundling the plurality of plated fibers is not needed and the plated fibers are covered with the coat. Accordingly, a normal cutting blade easily digs the coated plating fiber bundle, and thereby the coated plating fiber bundle is easily cut. Hence, complexity of terminal processing of a tension member is also reduced.

In addition, since the coated plating fiber bundle configures each electric wire, a work of extracting the electric wires one by one and connecting to a certain target is performed, but each electric wire is configured by bundling a plurality of the plated fibers based on the tensile force fiber, and thus, even if a weight is applied to one electric wire, probability that the electric wire is cut is reduced.

As described above, a diameter of the cable can be reduced, complexity of the terminal processing can be reduced, and probability that the electric wire is cut can be reduced.

According to one or more embodiments, in a multiple circuit cable, a diameter can be reduced so as to increase abrasion resistance. In addition, complexity of terminal processing can be reduced so as to reduce a probability that an electric wire is cut.

### BRIEF DESCRIPTION OF THE DRAWINGS

FIG. 1 is a perspective view illustrating a wire harness including a multiple circuit cable according to a first embodiment of one or more embodiments.

FIG. 2 is a perspective view illustrating details of the multiple circuit cable illustrated in FIG. 1.

FIG. 3 is a perspective view illustrating an example of a multiple circuit cable according to a comparative example.

FIGS. 4A and 4B are sectional views illustrating a state when an external force is applied to the multiple circuit cable according to the first embodiment and the comparative example, FIG. 4A illustrates a sectional view of the multiple circuit cable according to the first embodiment, and FIG. 4B illustrates a sectional view of the multiple circuit cable according to the comparative example.

FIG. 5 is a perspective view illustrating a multiple circuit cable according to a modification example of the first embodiment.

FIG. 6 is a sectional view illustrating a photoelectric composite cable according to a second embodiment of one or more embodiments.

FIG. 7 is a sectional view illustrating an example of a photoelectric composite cable according to a comparative example.

### DETAILED DESCRIPTION

Exemplary embodiments will be described with reference to the drawings.

### First Embodiment

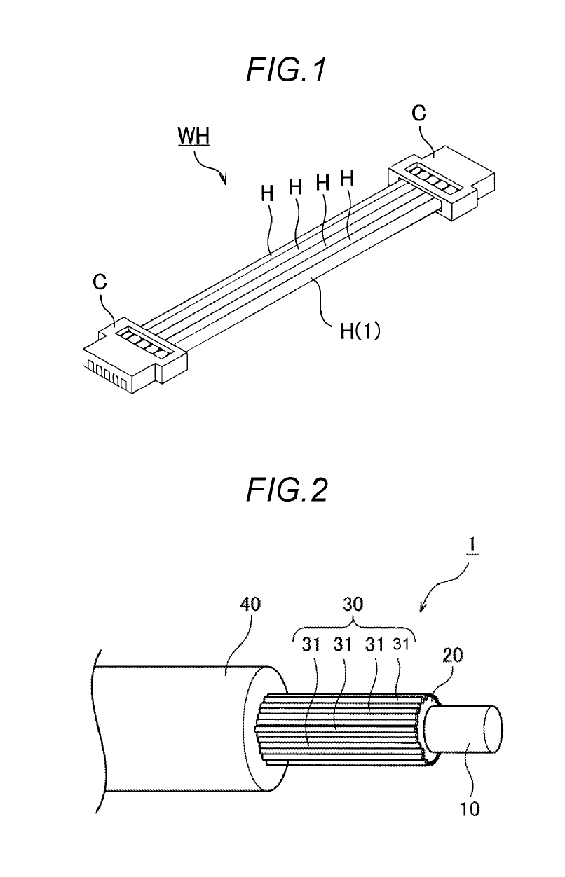

FIG. 1 is a perspective view illustrating a wire harness including a multiple circuit cable according to a first embodiment of the present invention. As illustrated in FIG. 1, the wire harness WH according to the present embodiment is configured by a multiple circuit cable 1 which includes a plurality of cables H in a bundle and is hereinafter described in detail, and other cables H which are disposed in parallel to be adjacent to the multiple circuit cable 1. For example, the wire harness WH may include connectors C at both ends of the cables H as illustrated in FIG. 1, and may be wound by a tape (not illustrated) so as to assemble the plurality of cables H. In addition, the wire harness WH may include an external component (not illustrated) such as a corrugated tube.

FIG. 2 is a perspective view illustrating details of the multiple circuit cable 1 illustrated in FIG. 1. The multiple circuit cable 1 illustrated in the present figure is configured to include an inside transfer body 10, an inside insulator 20 which covers an outer circumference of the inside transfer body 10, an outside transfer body 30 which is disposed in the outside of the inside insulator 20, and an outside insulator 40 which covers the outer circumference of the outside transfer body 30.

The inside transfer body 10 transfers a first signal or power, and is configured by, for example, a soft copper wire. In addition, the inside transfer body 10 may be configured by an optical fiber, and in this case, the inside transfer body 10 functions as a member which transfers an optical signal (first signal).

The outside transfer body 30 transfers a second signal or power, and is configured by a plurality of conductive fibers 31 with conductivity. It is recommended that the conductive fiber 31 is a conductive fiber with conductivity, such as a carbon fiber or a resin fiber having a metal filler. In addition, the conductive fiber 31 may be a polyester fiber, a nylon (registered trademark) fiber, an aramid fiber, a polyarylate fiber, a poly (p-phenylenebenzobisoxazole) (PBO) fiber, and a plated fiber which is produced by plating a metal on a carbon fiber.

Particularly, a tensile force fiber, such as the aramid fiber, the polyarylate fiber, the PBO fiber, and the carbon fiber is resistant to heat, tensile strength of the fiber is greater than or equal to 1 GPa, and an elastic modulus thereof is greater than or equal to 50 GPa, and thus, it is preferable that the conductive fiber 31 is any one of the fibers on which a metal is plated. It is preferable that the metal to be plated is configured by one or more metals of copper, tin, nickel, gold, and silver. Because the metal is easily plated and has high conductivity.

Furthermore, it is preferable that a diameter of the conductive fiber 31 is larger than or equal to 5 μm and smaller than or equal to 30 μm. The reason is that, if a diameter of a fiber is smaller than 5 μm, the conductive fiber 31 is too thin thereby being easily cut. In addition, the reason is that, if a diameter of the fiber is larger than 30 μm, the conductive fiber 31 is too thick thereby being hard to obtain effects which will be described below.

Furthermore, in the present embodiment, the outside insulator 40 has hardness which is greater than or equal to 10 and less than or equal to 90. Here, the hardness is a value that is measured by JISK6253 durometer type A (Shore A). Specifically, the outside insulator 40 is configured by any one or more of a silicone rubber, a fluorocarbon resin, an ethylene-propylene rubber, a chloroprene rubber, polyvinyl chloride (PVC), polypropylene (PP), polyethylene terephthalate (PET), polyethylene (PE), polyamide (PA), a poly phenylene sulfide resin (PPS), and polybutylene terephthalate (PBT).

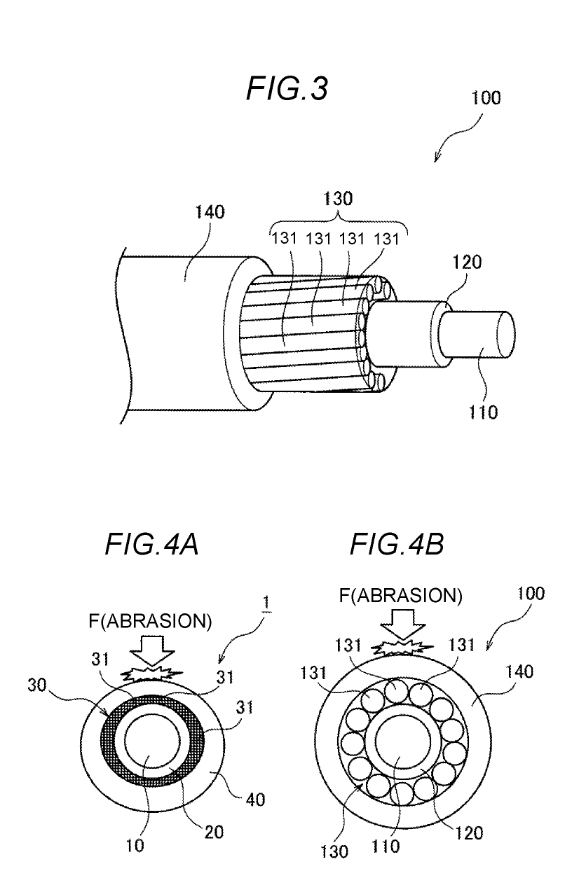

Next, actions or the like of the multiple circuit cable 1 according to the present embodiment will be described, but prior to this, a multiple circuit cable 100 according to a comparative example will be described. FIG. 3 is a perspective view illustrating an example of the multiple circuit cable according to the comparative example.

As illustrated in FIG. 3, the multiple circuit cable 100 according to the comparative example includes an optical fiber 110 which is a innermost layer, and an inside insulator 120 around that. In addition, the multiple circuit cable 100 according to the comparative example includes a metal conductor 130 with a pipe shape in which a plurality of metal wires 131 made of soft copper are laid without a gap on the outer circumference side of the inside insulator 120, and an outside insulator 140 which is disposed on the outside of the metal conductor 130.

FIGS. 4A and 4B are sectional views illustrating a state when an external force is applied to the multiple circuit cables 1 and 100 according to the present embodiment and the comparative example, FIG. 4A illustrates a sectional view of the multiple circuit cable 1 according to the present embodiment, and FIG. 4B illustrates a sectional view of the multiple circuit cable 100 according to the comparative example.

As illustrated in FIG. 4B, an external force F is first applied to the multiple circuit cable 100 according to the present embodiment. Here, the metal conductor 130 has a pipe shape in which a plurality of metal wires 131 are laid without a gap therebetween. For this reason, there is no gap in which the metal wires 131 are moved by the external force F, and the metal wires 131 itself are hard to be deformed from certain hardness. Particularly, the multiple circuit cable 100 according to the comparative example includes a hard transfer body such as the optical fiber 110 in the inside thereof, and thus, in a case where the external force F is applied to the multiple circuit cable 100, the hard optical fiber 110 receives the external force F. As the result, the outside insulator 140 is easily scraped.

Meanwhile, as illustrated in FIG. 4A, the external force F is applied to the multiple circuit cable 1 according to the present embodiment. Here, since the outside transfer body 30 is configured by the plurality of conductive fibers 31, a shape of the conductive fiber 31 itself changes to crush the conductive fiber, and the conductive fiber 31 moves to be interposed between other conductive fibers 31. In addition, since hardness of the outside insulator 40 is less than or equal to 90, the outside insulator is not so hard, thereby being appropriately deformed. Thereby, the multiple circuit cable 1 itself have a flat shape. That is, shapes of the multiple circuit cable 1 changes to dissipate the external force F, the outside insulator 40 is hard to be scraped, and abrasivity thereof is better than that of the comparative example.

Table 1 illustrates results of abrasion test of the multiple circuit cable 1 and 100 according to the present embodiment and the comparative example.

TABLE 1

| | Comparative example | Present embodiment |
|---|---|---|
| Outside insulator material | PVC (Shore A hardness 54) | |
| Thickness of outside | 0.2 mm | 0.2 mm |
| insulator | | |
| Number of times of | 450 | 515 |
| abrasion | | |

As illustrated in Table 1, the outside insulators 40 and 140 use polyvinyl chloride (PVC), hardness thereof was 54, in both the present embodiment and the comparative example. In addition, a thickness of the outside insulators 40 and 140 was 0.2 mm in both the present embodiment and the comparative example.

Abrasion of the multiple circuit cable 1 and 100 according to both the present embodiment and the comparative example was tested by using a scrape abrasion standard of ISO6722. In the test, a reciprocating movement of a needle was made in the longitudinal direction of the multiple circuit cable 1 and 100, in a state where the needle with a diameter of 0.45 mm intersects with the multiple circuit cable 1 and 100 and a weight of seven newton is applied to the needle. A sectional area that is occupied by inside configurations (the inside transfer body 10, the inside insulators 20 and 120, the outside transfer body 30, the optical fiber 110, the metal conductor 130) of the outside insulators 40 and 140 was 0.35 mm².

The number of times of abrasion illustrated in Table 1 indicates the number of reciprocating movement of the needle until the needle comes into contact with the outside transfer body 30 or the metal conductor 130. As illustrated in Table 1, the number of times of abrasion of the multiple circuit cable 1 according to the present embodiment was 515 and the number of times of abrasion of the multiple circuit cable 100 according to the comparative example was 450. That is, it can be seen that the number of times of abrasion of the multiple circuit cable 1 according to the present embodiment is increased by approximately 15%, compared to that of the multiple circuit cable 100 according to the comparative example.

In this way, according to the multiple circuit cable 1 of the present embodiment, the outside transfer body 30 is configured by the plurality of conductive fibers 31 with conductivity, and thus, a thickness thereof can be thinned, compared to a case where the outside transfer body is configured by the metal wires 131, without using the metal wire 131 with quite a large diameter. Furthermore, since the outside insulator 40 has hardness which is greater than or equal to 10 and less than or equal to 90 and the outside transfer body 30 is configured by the conductive fiber 31, the conductive fiber 31 is moved by the external force F so as to be interposed between other conductive fibers 31, and the outside insulator 40 itself is appropriately deformed, and thus, the multiple circuit cable 1 itself are flat-shaped, for example, under an environment in which the external force F is applied to the outside insulator 40 and thereby abrasion occurs. That is, the shape changes to dissipate the external force F, and thereby the outside insulator 40 can be hard to become worn out. Hence, it is possible to provide the multiple circuit cable 1 which can reduce a diameter and increase abrasion resistance.

Since the outside insulator 40 has hardness greater than or equal to 10, it is possible to prevent a situation from occurring in which the outside insulator 40 is too soft thereby being easily worn out. Since the outside insulator has hardness less than or equal to 90, it is possible to prevent a situation from occurring in which the outside insulator is too hard thereby being hard to be flattened.

In addition, since the conductive fiber 31 is a plated fiber in which a metal is plated on the fiber, the conductive fiber can be employed by adjusting a thickness of the plated metal, even in a circuit whose conductivity is insufficient only by a carbon fiber or the like with conductivity.

In addition, since the conductive fiber 31 is configured by plating one or more metals of copper, tin, nickel, gold, and silver on a fiber, it is possible to provide the conductive fiber 31 which is easily plated by a metal and has high conductivity.

In addition, the fiber is any one of an aramid fiber, a polyarylate fiber, a PBO fiber, and a carbon fiber. Since the fiber is resistant to heat, it is possible to connect the conductive fiber 31 to a terminal using solder. Furthermore, since the fiber has tensile strength greater than or equal to 1 GPa and has elastic modulus greater than or equal to 50 GPa, stress relaxation can be hard to occur in the fiber, when the terminal is attached to the conductive fiber 31 by pressing. Hence, when the terminal is connected, it is possible to prevent performance of product from being degraded.

In addition, since the conductive fiber 31 has a diameter greater than or equal to 5 μm, it is possible to prevent a situation from occurring in which the conductive fiber 31 is too thin thereby being easily cut. In addition, since the conductive fiber 31 has a diameter less than or equal to 30 μm, it is possible to prevent a situation from occurring in which the conductive fiber 31 is hard to be interposed between other conductive fibers 31 due to too great a thickness, and the multiple circuit cable 1 are hard to be flattened.

In addition, since the inside transfer body 10 is an optical fiber which transfers an optical signal, it is possible to provide the multiple circuit cable 1 in which a hard optical fiber receives the external force F from the outside of the cable, and in a situation where the more outside insulator 40 is scraped, a shape thereof is deformed to dissipate the external force F, and the outside insulator 40 can be hard to become worn out.

In addition, according to the wire harness WH of the present embodiment, since the multiple circuit cable 1 and other cables H disposed in parallel to be adjacent to the multiple circuit cable 1 are included, it is possible to provide the wire harness WH in which the adjacent cables H are pressed to the multiple circuit cable 1, or the multiple circuit cable 1 are pressed to the adjacent cables H, and thus, even in an environment where the multiple circuit cable 1 or other cables H are worn out, the multiple circuit cable 1 are flattened, and thereby the multiple circuit cable 1 or other cables H are not worn out.

As describe above, the present invention is described based on the first embodiment, but the present invention is not limited to the aforementioned embodiment, and modification thereof may be made within a range not departing from the gist of the present invention.

For example, the multiple circuit cable 1 according to the first embodiment are not limited to the description which is made with reference to FIG. 2, and various modifications can be made. For example, the inside transfer body 10 is not limited to one transfer body, and may be a plurality of transfer bodies.

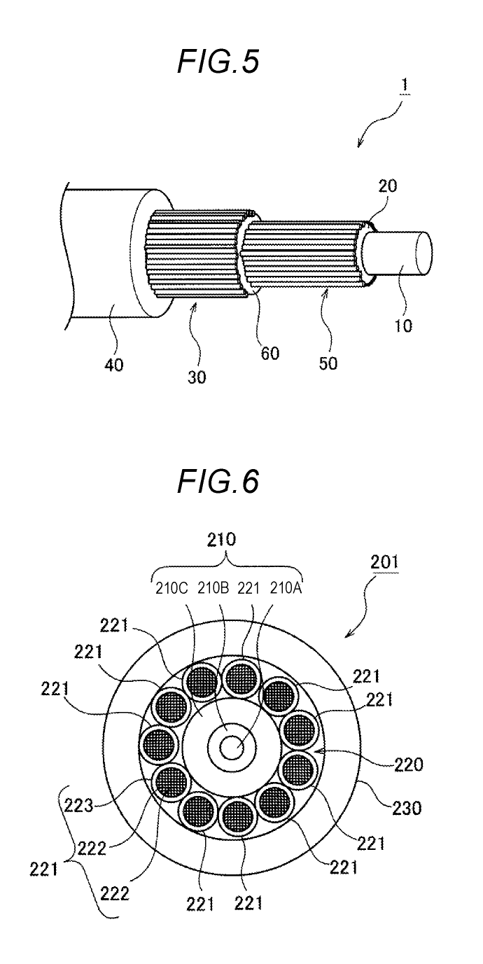

Furthermore, the multiple circuit cable 1 are not limited to a configuration including two circuits, and may have a configuration including three circuits or more. An example which includes three circuits is illustrated in FIG. 5. FIG. 5 is a perspective view illustrating a multiple circuit cable according to a modification example of the present embodiment. As illustrated in FIG. 5, the multiple circuit cable 1 according to the modification example include a medium transfer body 50 and a medium insulator 60 in addition to those of the present embodiment. The medium transfer body 50 has the same configuration as the outside transfer body 30. Also, the medium insulator 60 has the same configuration as the outside insulator 40.

By configuring in this way, for example, the medium transfer body 50 is used as a positive power supplying path and the outside transfer body 30 is used as a negative power supplying path, and thereby, one set of the multiple circuit cable 1 can supply power to one machine.

### Second Embodiment

FIG. 6 is a sectional view illustrating a photoelectric composite cable according to a second embodiment of the present invention. The photoelectric composite cable at the present embodiment configures a multiple circuit cable. The photoelectric composite cable 201 illustrated in the present figure is configured with an optical fiber 210, an electric wire layer 220 which is provided on an outer circumference side of the optical fiber 210, and a sheath 230 which is provided on an outer circumference side of the electric wire layer 220.

The optical fiber 210 is configured with a core 210A, cladding 210B, and a coat 210C. The core 210A is a transfer path through which an optical signal is transferred, and the cladding 210B is disposed around the core 210A, a refractive index of the cladding is less than a refractive index of the core 210A, and the cladding functions as a portion which confines the optical signal in the core 210A. The coat 210C is a portion which covers the cladding.

The electric wire layer 220 is configured by disposing a plurality of coated plating fiber bundles 221 around the optical fiber 210.

Here, the coated plating fiber bundle 221 is configured by a plurality of plated fibers 222 and a resin 223 which coats a bundle of a plurality of plated fibers 222. The plated fiber 222 is configured by plating a metal on a tensile force fiber. In the present embodiment, the tensile force fiber is configured by any one of an aramid fiber, a polyarylate fiber, a poly (p-phenylenebenzobisoxazole) (PBO) fiber, and a carbon fiber, and the plating metal is configured by one or more metals of copper, tin, nickel, gold, and silver. Furthermore, the resin 223 is configured by an insulating thermoplastic resin, such as polyvinyl chloride (PVC), polyethylene (PE), polypropylene (PP), and polyethylene terephthalate (PET).

The coated plating fiber bundle 221 has a function of an electric wire for transferring electric power and a function of an electric wire for transferring an electrical signal, and is connected to a connection destination according to each purpose.

The sheath 230 collectively holds the optical fiber 210 and the electric wire layer 220, and protects these. A tape wound layer, a shield layer, or the like may be appropriately provided between the electric wire layer 220 and the sheath 230, while not illustrated.

Here, it is generally known that a tension member is included around the optical fiber 210, and the tension member is configured by a tensile force fiber. That is, in the present embodiment, the tensile force fiber has conductivity by plating a metal on the tensile force fiber, and the coated plating fiber bundle 221 is configured by bundling a plurality of plated fibers 222, and thereby the coated plating fiber bundle 221 can be replaced with an electric wire which is described in Patent Literature 1.

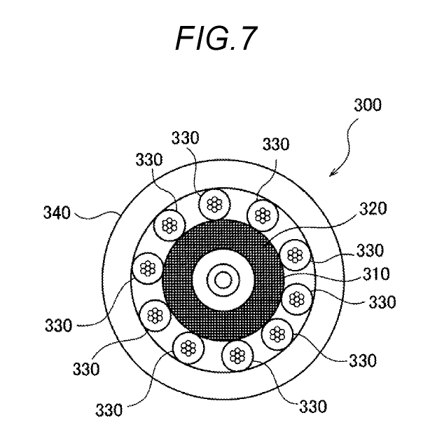

Next, an action of the photoelectric composite cable 201 according to the present embodiment will be described, but prior to this, a photoelectric composite cable 300 according to a comparative example will be described. FIG. 7 is a sectional view illustrating an example of the photoelectric composite cable according to the comparative example.

As illustrated in FIG. 7, the photoelectric composite cable 300 according to the comparative example includes an optical fiber 310 as an innermost layer, and includes a tension member 320 which is configured by a tensile force fiber around that. In addition, the photoelectric composite cable 300 according to the comparative example includes a plurality of electric wires 330 on the outer circumference side of the tension member 320, and includes a sheath 340 on the outside of the plurality of electric wires 330.

As illustrated in FIG. 7, the photoelectric composite cable 300 according to the comparative example has a structure which essentially includes three layers of the optical fiber 310, the tension member 320, and the electric wire 330. For this reason, a diameter of the photoelectric composite cable 300 is increased by overlapping the three layers.

Furthermore, since the photoelectric composite cable 300 according to the comparative example has a three-layer structure, terminal processing of each of the three layers is needed. That is, it is necessary to perform 1) connection processing of the optical fiber 310, 2) processing of maintaining tension of the tension member 320, and 3) connection processing of the electric wire 330, and the terminal processing is significantly complicated.

In contrast to this, the photoelectric composite cable 201 according to the present embodiment has a structure including two layers of the optical fiber 210 and the electric wire layer 220, as illustrated in FIG. 6. Hence, by overlapping the two layers, a diameter of a cable can be smaller than a diameter of the photoelectric composite cable 300 according to the comparative example.

In addition, also in terminal processing, 1) connection processing of the optical fiber 210 and 2) connection processing of the coated plating fiber bundle 221 of the electric wire layer 220 may only be performed, and thus, the terminal processing can be simplified. That is, an electrical connection is performed by connecting the coated plating fiber bundle 221 to a predetermined target, and thereby processing of maintaining the tension is simultaneously performed, and the terminal processing is simplified.

In addition, since the photoelectric composite cable 300 according to the comparative example includes the tension member 320 which is simply configured by a tensile force fiber, processing of maintaining cutting or tension is performed in the terminal processing, after a certain number of tensile force fibers are bundled. For this reason, a bundling work itself is complicated, and furthermore, it is difficult to cut the tensile force fiber with a normal cutting blade, and the cutting work is also complicated.

In contrast to this, the photoelectric composite cable 201 according to the present embodiment includes the coated plating fiber bundle 221 which is coated with a resin after a plurality of the plated fibers 222 are bundled, and thus, work of bundling a plurality of the plated fibers 222 is not needed and the plated fibers are covered with a coat. Accordingly, a normal cutting blade easily digs the coated plating fiber bundle 221, and thereby the coated plating fiber bundle is easily cut.

In addition, in the photoelectric composite cable 300 according to the comparative example, the electric wires 330 which are disposed around the optical fiber 310 have to be thinned to be employed, and thus, work of extracting the electric wires 330 one by one to connect to a certain target is performed. Hence, as a weight is applied to one thin electric wire 330, there is a high probability that the electric wire is cut.

In contrast to this, in the photoelectric composite cable 201 according to the present embodiment, the coated plating fiber bundle 221 configures each electric wire, and thus, work of extracting the electric wires one by one and connecting to a certain target is performed, but each electric wire is configured by bundling a plurality of the plated fibers 222 based on the tensile force fiber, and thus, even if a weight is applied to one electric wire, probability that the electric wire is cut is reduced.

As described above, in the photoelectric composite cable 201 according to present embodiment, the plated fiber 222 is generally configured by providing conductivity to the tensile force fiber which is disposed around the optical fiber 210, the coated plating fiber bundle 221 is configured by bundling a plurality of the plated fibers, and thereby the coated plating fiber bundle 221 can be replaced with the electric wire described in Patent Literature 1. Accordingly, the photoelectric composite cable 201 which can simultaneously achieve the aforementioned actions or the like is provided.

In this way, according to the photoelectric composite cable 201 of the present embodiment, the electric wire layer 220 is configured by disposing a plurality of the coated plating fiber bundles 221 which are coated with the resin 223 by bundling a plurality of the plated fibers 222 in which a metal is plated on a tensile force fiber, around the optical fiber 210. For this reason, the coated plating fiber bundle 221 having functions of both the tension member and the electric wire is disposed around the optical fiber 210. Thereby, the photoelectric composite cable 201 can have a two-layer structure of the optical fiber 210 and the electric wire layer 220, a diameter of the cable can be reduced.

Furthermore, since the photoelectric composite cable 201 has the two-layer structure, terminal processing may be performed only for two layers, and thus, complexity is reduced. Particularly, since the coated plating fiber bundle 221 is configured by bundling a plurality of the plated fibers 222 and is coated with the resin 223, work of bundling the plurality of plated fibers 222 is not needed and the plated fibers are coated with the resin 223. Accordingly, a normal cutting blade easily digs the coated plating fiber bundle 221, and thereby the coated plating fiber bundle is easily cut. Hence, complexity of terminal processing of a tension member is also reduced.

In addition, since the coated plating fiber bundle 221 configures each electric wire, work of extracting the electric wires one by one and connecting to a certain target is performed, but each electric wire is configured by bundling a plurality of the plated fibers 222 based on the tensile force fiber, and thus, even if a weight is applied to one electric wire, probability that the electric wire is cut is reduced.

As described above, a diameter of the cable is reduced, complexity of the terminal processing is reduced, and probability that the electric wire is cut can be reduced.

In addition, since the plated fiber 222 is plated by one or more metals of copper, tin, nickel, gold, and silver, it is possible to obtain the plated fiber 222 which has relatively high conductivity and is plated by a metal whose plating processing is easily performed.

In addition, the tensile force fiber is any one of an aramid fiber, a polyarylate fiber, a PBO fiber, and a carbon fiber. Here, since the fiber is resistant to heat, the fiber can connect the coated plating fiber bundle 221 to a terminal using solder. In addition, since the fiber has tensile strength greater than or equal to 1 GPa and has elastic modulus greater than or equal to 50 GPa, stress relaxation can be hard to occur in the tensile force fiber when the coated plating fiber bundle 221 is attached to a terminal by pressing. Hence, when the terminal is connected, it is possible to prevent performance of product from being degraded.

In addition, since a plurality of plated fibers are extruded and coated with a thermoplastic resin, adhesion between the resin and the plated fiber can be controlled, and coat removing processing of a terminal can be easily performed.

Particularly, JP-A-2013-140290 discloses a technique of coating a tension member with a UV-curable resin. However, if the tension member is coated with the UV-curable resin, adhesion between the fiber and the resin is too strong, and thus, a coated material is hard to be removed. However, by coating a member with a thermoplastic resin, a problem that the coated material is hard to be removed does not occur as described above.

As such, the present invention is described based on the second embodiment, but the present invention is not limited to the aforementioned embodiment, and modification thereof may be made within a range not departing from the gist of the present invention.

For example, the photoelectric composite cable 201 according to the second embodiment is not limited to the description that is made with reference to FIG. 6, and various modifications can be made. For example, the optical fiber 210 is not limited to one piece, and may be plural.

Furthermore, the tensile force fiber according to the second embodiment is any one of an aramid fiber, a polyarylate fiber, and a PBO fiber, but is not limited to these, and may be a polyester fiber or a nylon (registered trademark) fiber.

Here, characteristics of the embodiments of the multiple circuit cable according to the present invention described above will be respectively listed briefly and collectively in [1] to [11] hereinafter.

[1] A multiple circuit cable (1) comprising:

an inside transfer body (10) that transfers a first signal or a first power;

an inside insulator (20) that covers an outer circumference of the inside transfer body;

an outside transfer body (30) that is disposed on an outside of the inside insulator and transfers a second signal or a second power; and

an outside insulator (40) that covers an outer circumference of the outside transfer body,

wherein the outside transfer body is configured with a plurality of conductive fibers (31) having conductivity, and

wherein the outside transfer body has a thickness so that an outer shape is flattened into a flat-shape when an external force is applied.

[2] The multiple circuit cable described in the above-mentioned [1], wherein each of the conductive fibers is a plated fiber in which plating a metal on a fiber is performed.

[3] The multiple circuit cable described in the above-mentioned [2], wherein the each of the conductive fibers is plated by one or more metals of copper, tin, nickel, gold, and silver on the fiber.

[4] The multiple circuit cable described in the above-mentioned [2] or [3], wherein the fiber is any one of an aramid fiber, a polyarylate fiber, a PBO fiber, and a carbon fiber.

[5] The multiple circuit cable described in any one of the above-mentioned [1] to [4], wherein the each of the conductive fibers has a diameter which is larger than or equal to 5 μm and smaller than or equal to 30 μm.

[6] The multiple circuit cable described in any one of the above-mentioned [1] to [5], wherein the inside transfer body is an optical fiber which transfers an optical signal.

[7] A wire harness (WH) comprising:

the multiple circuit cable described in any one of the above-mentioned [1] to [6]; and

another cable that is disposed in parallel to be adjacent to the multiple circuit cable.

[8] A multiple circuit cable (photoelectric composite cable 201) comprising:

an optical fiber (210) that transfers an optical signal; and

a plurality of electric wire layers (220) that are disposed around the optical fiber,

wherein the electric wire layer is a coated plating fiber bundle (221), and

wherein the coated plating fiber bundle is a bundle of a plurality of plated fibers (222), the bundle is coated with a resin, and each of the plurality of plated fibers is plated by a metal on a tensile force fiber.

[9] The multiple circuit cable described in the above-mentioned [8], wherein the each of the plurality of the plated fibers is plated by one or more metals of copper, tin, nickel, gold, and silver on the tensile force fiber.

[10] The multiple circuit cable described in the above-mentioned [8] or [9], wherein the tensile force fiber is any one of an aramid fiber, a polyarylate fiber, a PBO fiber, and a carbon fiber.

[11] The multiple circuit cable described in any one of the above-mentioned [8] to [10], wherein the coated plating fiber bundle is the plurality of the plated fibers that are coated with a thermoplastic resin respectively.

[12] The multiple circuit cable described in the above-mentioned [1], wherein the outside insulator has Shore A hardness which is greater than or equal to 10 and less than or equal to 90.

The present invention is described in detail or with reference to the specific embodiment, but it is apparent to those skilled in the art that various changes or modifications thereof can be made without departing from the spirit and the scope of the present invention.

### INDUSTRIAL APPLICABILITY

According to the present invention, it is possible to provide a multiple circuit cable in which a diameter can be reduced and abrasion resistance can be increased. In addition, there are effects in which it is possible to provide a multiple circuit cable that can reduce a diameter of the cable, reduce complexity of terminal processing, and reduce a probability that an electric wire is cut. The present invention which obtains the effects is useful for a multiple circuit cable.

### DESCRIPTION OF REFERENCE NUMERALS AND SIGNS

1 MULTIPLE CIRCUIT CABLE
10 INSIDE TRANSFER BODY
20 INSIDE INSULATOR
30 OUTSIDE TRANSFER BODY
31 CONDUCTIVE FIBER
40 OUTSIDE INSULATOR
50 MEDIUM TRANSFER BODY
60 MEDIUM INSULATOR
201 PHOTOELECTRIC COMPOSITE CABLE
210 OPTICAL FIBER
210A CORE
210B CLADDING
210C COAT
220 ELECTRIC WIRE LAYER
221 COATED PLATING FIBER BUNDLE
222 PLATED FIBER
223 RESIN
230 SHEATH
C CONNECTOR
F EXTERNAL FORCE
H CABLE
WH WIRE HARNESS

What is claimed is:

1. A multiple circuit cable comprising:
an inside transfer body that transfers a first signal or a first power;
an inside insulator that covers an outer circumference of the inside transfer body;
an outside transfer body that is disposed on an outside of the inside insulator and transfers a second signal or a second power; and
an outside insulator that covers an outer circumference of the outside transfer body,
wherein the outside transfer body includes a plurality of conductive fibers having conductivity, and
wherein the outside transfer body has a thickness so that an outer shape is flattened into a flat-shape when an external force is applied.

2. The multiple circuit cable according to claim 1, wherein each of the conductive fibers is a plated fiber in which plating a metal on a fiber is performed.

3. The multiple circuit cable according to claim 2, wherein the each of the conductive fibers is plated by one or more metals of copper, tin, nickel, gold, and silver on the fiber.

4. The multiple circuit cable according to claim 2, wherein the fiber is any one of an aramid fiber, a polyarylate fiber, a PBO fiber, and a carbon fiber.

5. The multiple circuit cable according to claim 2, wherein the each of the conductive fibers has a diameter which is larger than or equal to 5 μm and smaller than or equal to 30 μm.

6. The multiple circuit cable according to claim 1, wherein the inside transfer body is an optical fiber which transfers an optical signal.

7. A wire harness comprising:
the multiple circuit cable according to claim 1; and
another cable that is disposed in parallel to be adjacent to the multiple circuit cable.

8. A multiple circuit cable comprising:
an optical fiber that transfers an optical signal; and
an electric wire layer that is disposed around the optical fiber,
wherein the electric wire layer includes a plurality of coated plating fiber bundles, and
wherein each of the plurality of the coated plating fiber bundles is a bundle of a plurality of plated fibers, the bundle is coated with a resin, and each of the plurality of plated fibers is plated by a metal on a tensile force fiber.

9. The multiple circuit cable according to claim 1, wherein the outside insulator has Shore A hardness which is greater than or equal to 10 and less than or equal to 90.
